(19) United States
(12) Patent Application Publication
(10) Pub. No.: US 2009/0314436 A1
(43) Pub. Date: Dec. 24, 2009

(54) BEAD SUPPLY SYSTEM IN TIRE BUILDING PROCESS

(75) Inventors: Tetsuo Tatara, Osaka (JP); Tomoyuki Takatsuka, Osaka (JP); Hirokatsu Mizukusa, Osaka (JP); Osamu Fujiki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOYO TIRE & RUBBER CO., LTD., Osaka-shi, Osaka (JP)

(21) Appl. No.: 12/096,438

(22) PCT Filed: Dec. 7, 2005
(86) PCT No.: PCT/JP2005/022481

§ 371 Date: Apr. 3, 2009

(51) Int. Cl. B29D 30/18

(52) U.S. Cl. 156/398

(57) ABSTRACT

The invention provides a bead supply system which stocks annular beads without bringing the beads into contact with each other and supplies the beads to a building machine in steps where bead setting and turning up are carried out in tire building and includes a bead stocking unit (10) having a transfer means (20) for holding a plurality of beads in such a manner as to be spaced apart from each other at constant intervals and transferring the beads towards a distal end portion, a bead transfer unit (40) for receiving the beads one by one from the bead stocking unit (10) to transfer them to a loading waiting position (P1) on to a building machine (100), and a loading and setting unit (60) for receiving the beads from the bead transfer unit (40) in the loading waiting position (P1) to supply them to a loading and setting position (P2) which confronts two supporting elements of the building machine, wherein the respective units are made to operate in an associated fashion in accordance with a tire building cycle so as to load and set the beads on both the supporting elements (101)(102) of the building machine.

### TECHNICAL FIELD

The present invention relates to a bead supply system for supplying annular beads to a building machine in bead setting and turning up steps in a tire building process.

### BACKGROUND ART

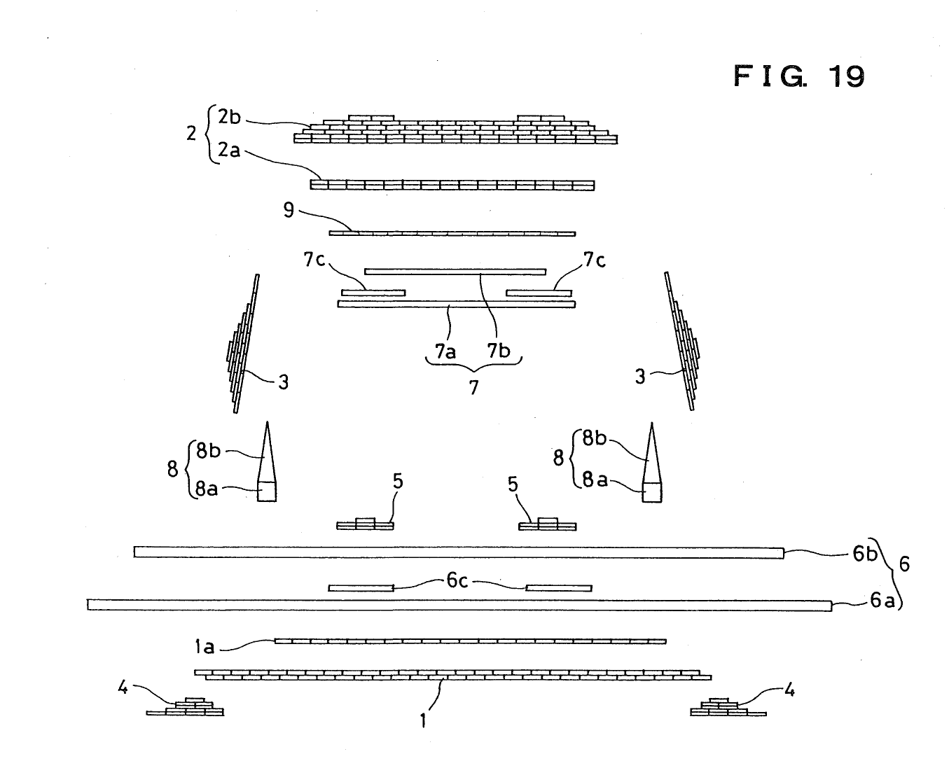

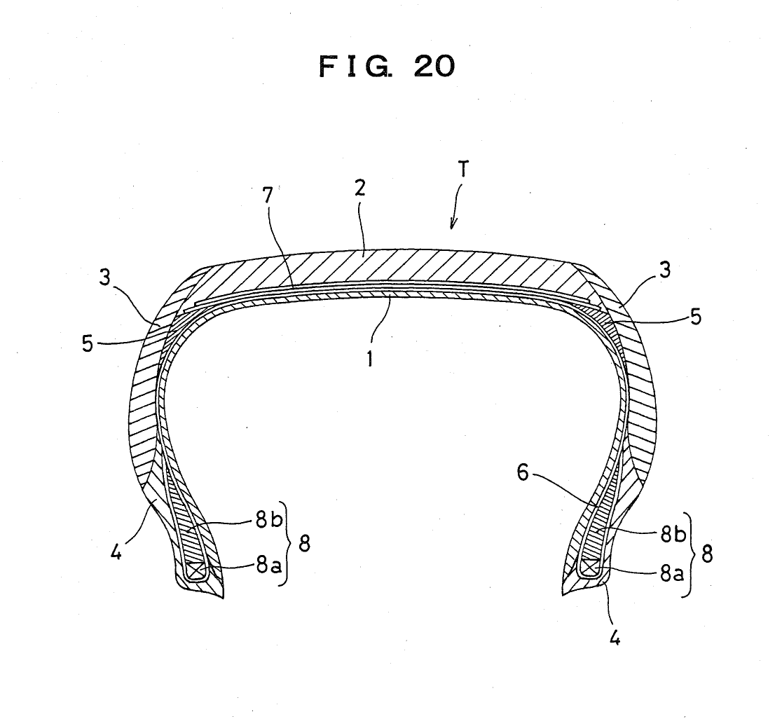

Tires are made up of a plurality of reinforcement members which are, in turn, made up mainly of pluralities of rubber members and cords. To represent them, as is shown in FIG. 20, parts such as an inner liner 1, a tread 2, side walls 3, rim strips or chafers 4 and furthermore, pads 5 under belts are formed of rubber members which meet properties required for the respective parts, and these rubber members are combined with a carcass layer 6 and a belt layer 7, which are reinforcement members containing cords, and beads 8 to thereby make up a tire T. An example of constituent members of a tire is shown in FIG. 19 in an exploded fashion.

In FIG. 19, the tread 2 is made up of a tread base 2a and a tread cap 2b. In addition, the carcass layer 6 is made up of primary and secondary carcass plies 6a, 6b, and the belt layer 7 is made up of a plurality of belts 7a, 7b. The bead 8 is made up of a bead core 8a, which is a reinforcement member such as a wire, and a filler rubber 8b. In the figure, reference numeral la denotes a rubber layer referred to as a squeegee, 6c tapes between the plies and 7c belt edge tapes, any of which is made up of a rubber member. Reference numeral 9 denotes a reinforcement tape containing fabric cords which is wound round on the belt layer 7.

In recent years, as a building method for the tire, there is proposed a method including setting building positions individually for tire constituent members, and transferring a building drum or building elements themselves which are built up on the building drum to the respective building positions so that the respective constituent members are built up and laminated for building up a green tire before vulcanization. Furthermore, there is also proposed a building method in which in building the tire, with respect to rubber members such as an inner liner and a tread, unvulcanized rubber strips which are extruded in the form of a ribbon are spirally superimposed to be wound in the respective building positions (Patent Documents Nos. 1 to 4).

Incidentally, in bead setting and turning up steps of the tire building process, in such a state that the building drum is supported in a cantilever fashion by one of two support elements, which confront each other, making up a building machine used in the steps, annular beads are set in predetermined positions on both the support elements, and thereafter, the building drum, which has received a circular cylindrical carcass band transferred from a band building step, is supported by both the support elements from both sides. In this state, the beads set on both the support elements are forced to be set in both end portions of the carcass band on the building drum, and furthermore, the end portions are turned up, so as to build a green casing.

Conventionally, while in the bead setting operation of setting beads on the building machine in the bead setting and turning up steps, beads stocked on a supply carriage or the like have been manually loaded to be set on both the support elements by a worker, since the operation has involved many labor hours and the worker has been necessary to be involved, this manual operation has constituted a barrier to improvement in tire building efficiency and automation of tire building. Because of this, the automation of the bead supply and setting operations on to the building machine has been demanded and various trials have been made.

The inventor and others have also tried to automate the bead supply and setting operations on to the building machine by feeding and supplying individually beads from where beads are stocked in such a way as to match a tire building cycle. In this case, since the beads are formed into an annular shape in which an unvulcanized filler rubber having a substantially triangular cross section is added to an outer circumference of a bead core, in the event that filler rubbers are in contact with each other in the stock section, contact portions become something like being bonded together, leading to problems that the contact portions become resistant to easy separation and that when attempting to forcibly separate the contact portions from each other, deformation is generated. Consequently, in the case of the bead supply and setting operations to and on the building machine being automated, it is desired that beads can be supplied individually without generating the deformation or the like of the filler rubbers.

Patent Document No. 1: JP-B-6-51367

Patent Document No. 2: JP-A-9-29858

Patent Document No. 3: JP-A-2002-178415

Patent Document No. 4: JP-A-2002-205512

### DISCLOSURE OF THE INVENTION

### Problem that the Invention is to Solve

The invention has been made with a view to solving the problems, and an object thereof is to provide a bead supply system for in bead setting and turning up steps of a tire building process, automatically supplying and setting the annular beads on to a building machine which supports a building drum in the steps in accordance with a building cycle of a tire and more particularly a bead supply system for sequentially feeding the beads for supply from where the beads are stocked without filler rubbers being brought into contact with each other.

### Means for Solving the Problem

According to the invention, there is provided a bead supply system in a tire building process for in bead setting and turning up steps in tire building, supplying an annular bead made up by having a bead core and a filler rubber to a building machine which supports a building drum in the steps, the bead supply system including:

a bead stocking unit having a supporting arm portion which is supported horizontally at one end portion so that a plurality of the beads are locked from inner circumferences thereof so as to be held in such a manner as to be spaced apart at constant intervals along the supporting arm portions and a transfer means for transferring the beads so held intermittently towards an open end of the supporting arm portion so that the beads are fed out one by one;

a bead transfer unit having a holding means for receiving the beads, one by one, which are fed out from an end portion of the transfer means which lies at the open end while supporting the bead on the inner circumference thereof and holding the beads so received in a position which confronts the bead stocking unit and adapted to move from the confronting position to a loading waiting position on to the building machine while holding the beads; and

a loading and setting unit having a holding means for receiving the beads from the bead transfer unit while supporting the bead on the inner circumference thereof and holding the beads so received in the loading waiting position and adapted to move to a position where to confront two supporting elements of the building machine while holding the beads so as to enabling loading and setting of the beads on to both the supporting elements, wherein

the respective units are operated in an associated fashion in accordance with a tire building cycle so that the beads can be loaded and set on both the supporting elements of the building machine.

By this configuration, the annular beads made up by having the bead core and bead filler can sequentially be fed out one by one in accordance with the tire building cycle from where the beads are stocked while being held in such a manner as to be spaced apart from each other so that the filler rubbers are not brought into contact with each other and the beads so fed out can be held on the loading and setting unit on to the building machine in the steps where bead setting and turning up are performed, whereby the beads can be supplied to the position where the beads confront both the supporting elements of the building machine for loading and setting thereonto. Moreover, since the beads are supported from the inner circumferences thereof where the bead cores reside at all times, there is caused no fear that deformation is generated in the filler rubbers of the beads while the beads are stocked or transferred.

In the bead supply system in a tire building process, the bead stocking unit can be configured such that the one end portion of the supporting arm portion is fixed continuously to a supporting pillar provided on a rotatable base table in such a manner as to be erected therefrom so that the supporting arm portion is supported horizontally, and that the transfer means is provided along the supporting arm portion, whereby by rotating the base table with a required number of beads locked on the transfer means, the end portion of the transfer means which lies at the open end can be directed from a non-confronting side to a confronting side with the bead transfer unit.

By this configuration, in such a state that the transfer means of the bead stocking unit is directed to the non-confronting side with the bead transfer unit, for example, to an opposite direction thereto, the required number of beads is locked to be held on the transfer means from the open end, and thereafter, the end portion of the transfer means can be rotated so as to be directed to the confronting side with the bead transfer unit. Because of this, the bead supply and locking operations on to the bead stocking unit can be performed easily, and moreover, the transfer and reception of the beads on to and by the bead transfer unit can be performed in a smooth manner by making use of the transferring action by the transfer means.

In the bead supply system in a tire building process, upper and lower transfer means are preferably provided on the bead stocking unit for holding the bead at upper and lower portions on the inner circumference thereof in a locked state in such a manner as to be driven individually along the supporting arm portion in synchronism with each other, thereby making it possible to hold the bead which is locked on the transfer means at upper and lower positions with good stability.

In particular, in a case where left and right transfer means for holding the bead at left and right portions on the inner circumference thereof in a locked state are provided in left and right positions which lie vertically intermediate between the upper and lower transfer means in such a manner as to be individually driven along the supporting arm portion in synchronism with the upper and lower transfer means, since the bead can be held by locking it in the upper and lower positions, as well as in the left and right positions by the upper and lower transfer means, as well as by the left and right transfer means, the bead can be transferred while maintaining the stable holding condition without generating lateral oscillations or deviations, and the transfer and reception of the bead on to and by the holding means of the bead transfer unit can be ensured.

The transfer means of the bead stocking unit is preferably made up of an endless rotatable member which can rotate backwards and forwards and which has pins provided on an external surface thereof at constant intervals in such a manner as to project therefrom for holding the beads in such a manner as to be spaced apart from each other, and the pins are preferably provided in such a manner as to turn in such a manner as to project from a distal end of the supporting arm portion at a turning portion of the rotatable member at the open end portion.

By this configuration, when locking the bead on the transfer means, while rotationally driving the rotatable member in an opposite direction to the feeding direction by hooking one bead on each of the pins at the turning portion at the open end portion, the beads can easily be locked and held at constant intervals, and moreover, by rotationally driving the rotatable member in the feeding direction, the transfer and reception of the bead on to and by the bead transfer unit can be implemented without any problem.

Furthermore, in the bead supply system in a tire building process, the bead transfer unit is preferably provided in such a manner as to move in an approaching direction relative to the end portion of the transfer means at least in a position which confronts the end portion of the transfer means of the bead stocking unit which lies at the open end. By this configuration, the reception of the bead from the end portion of the transfer means is ensured.

In addition, the bead transfer unit preferably includes as a holding means for holding a bead a plurality of locking members adapted to be locked on an inner circumferential edge of the bead which are provided in such a manner as to be displaced in a radial direction in synchronism with each other in positions which are located at required intervals in a circumferential direction on a side which confronts the end portion of the transfer means which lies at the open end. By this configuration, the bead fed out from the transfer means can be received and held on the locking members in an ensured fashion.

In the bead supply system in a tire building process, the loading and setting unit preferably has a holding means for receiving the bead from the bead transfer unit to hold the bead thereon which is provided on each of both axial surfaces thereof, is preferably supported in such a manner as to be turned so that the holding means on both the surfaces are directed alternately to a side which confronts the bead transfer unit, and is preferably made to move to the position where to confront the two supporting elements of the building machine while holding two beads with the holding means on both the surfaces.

By this configuration, through the movement of the loading and setting unit to the position where to confront both the supporting elements of the building machine with the beads held on the axial surfaces thereof, the beads can be supplied to be loaded and set on to both the supporting elements through the single moving action, whereby the setting operation of the beads on to both the supporting elements can be facilitated, thereby making it possible to shorten time required for the bead setting operation.

### ADVANTAGE OF THE INVENTION

As has been described heretofore, according to the bead supply system of the invention, in the bead setting and turning up steps during the tire building process, since, by causing a required number of beads to be held on the bead stocking unit which can feed beads one by one in such a manner as to be spaced apart from each other while being locked on the inner circumferences thereof, the beads can sequentially be transferred for loading and setting in accordance with the tire building cycle without bringing the beads into contact with each other, the bead loading and setting operations on to the building machine can be simplified, thereby making it possible not only to automate the supply of beads but also to contribute to the enhancement of tire building efficiency. In particular, by configuring the beads to be supported from the inner circumferences thereof where the bead cores reside at all times and preventing the beads from being brought into contact with each other, there is caused no fear that filler rubbers of the beads are deformed while being stocked or transferred, thereby making it possible to automate the supply of beads with no problem.

### BEST MODE FOR CARRYING OUT THE INVENTION

Next, a mode for carrying out the invention will be described based on an embodiment shown in drawings.

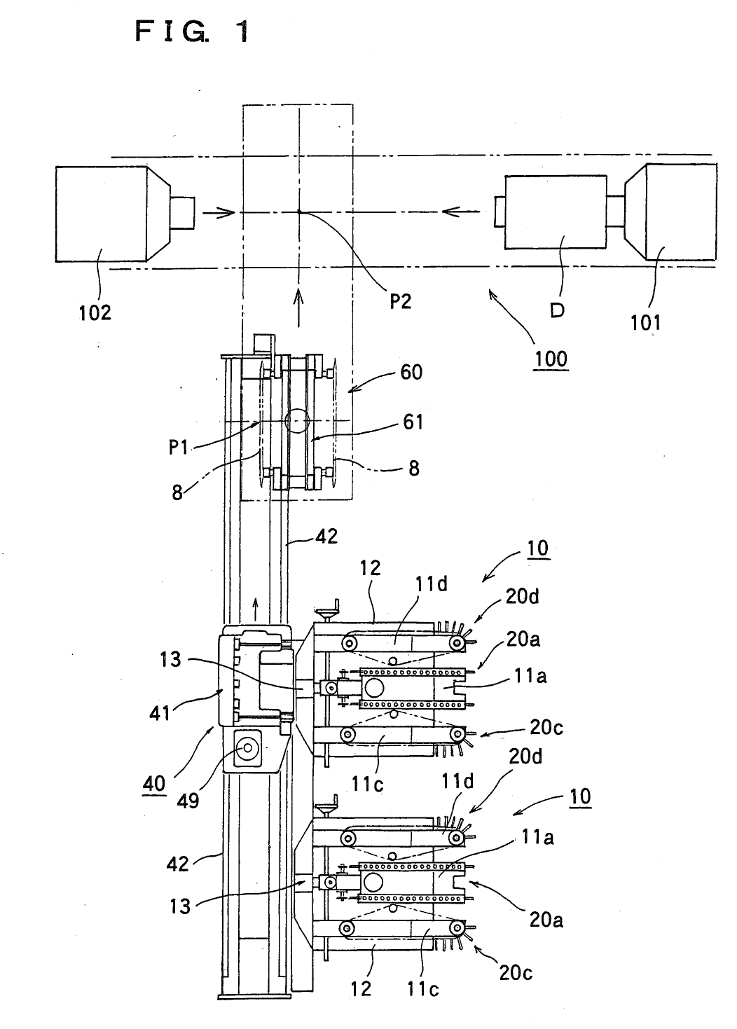

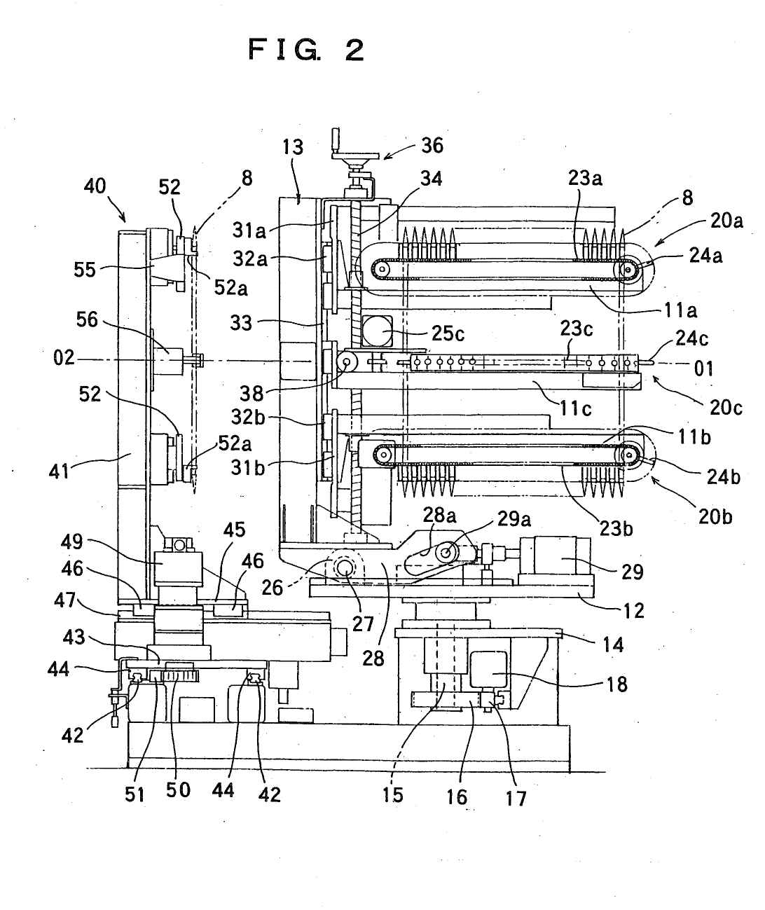

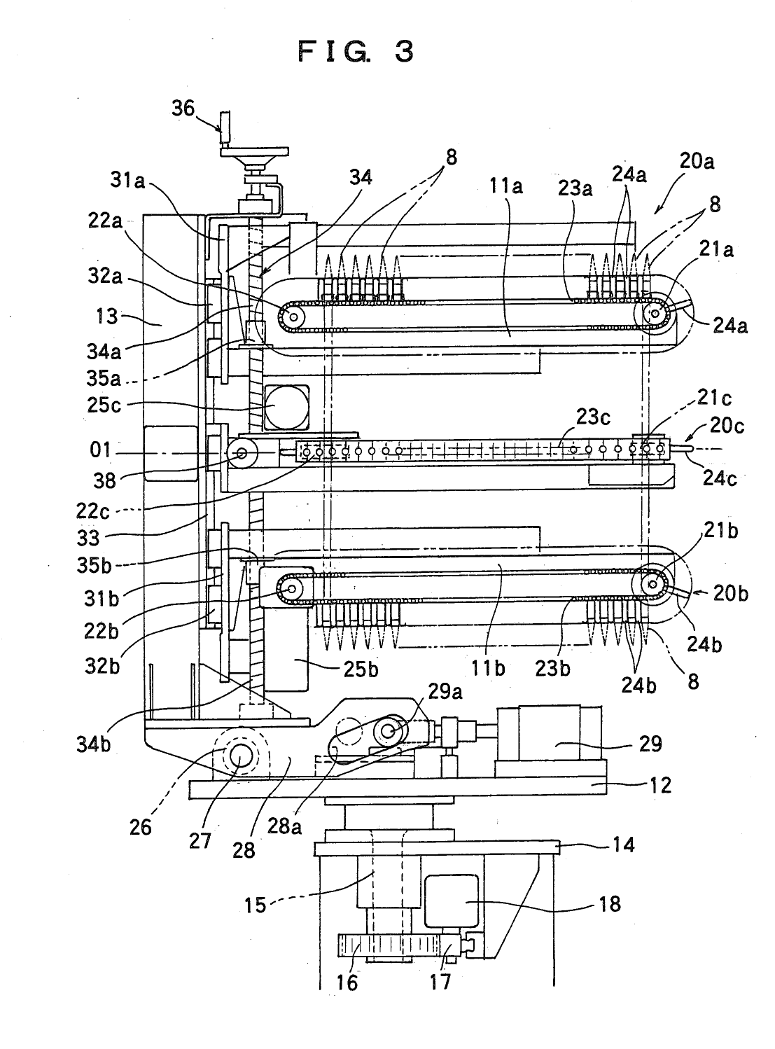

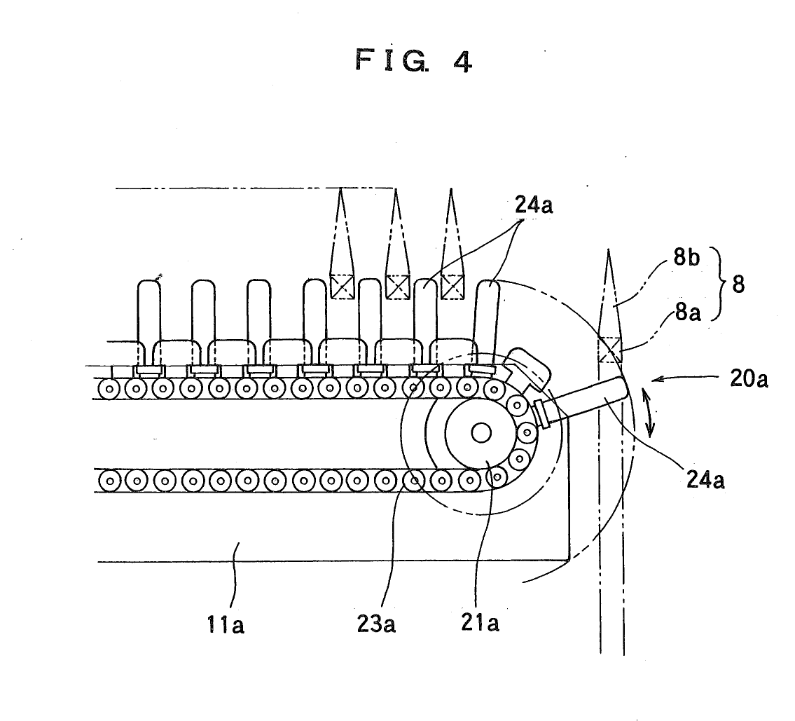

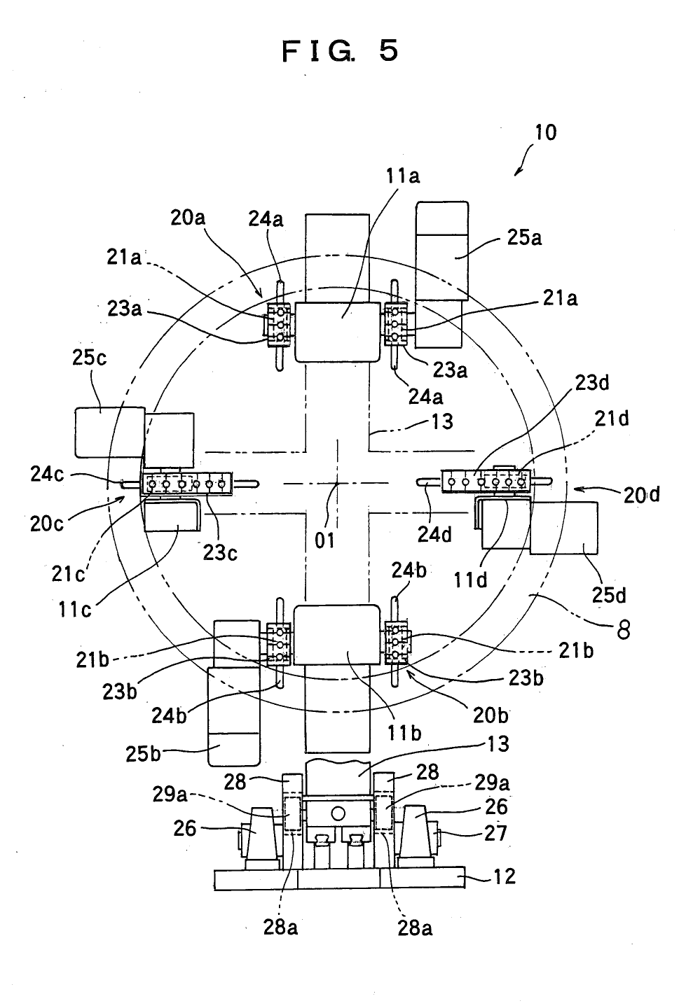

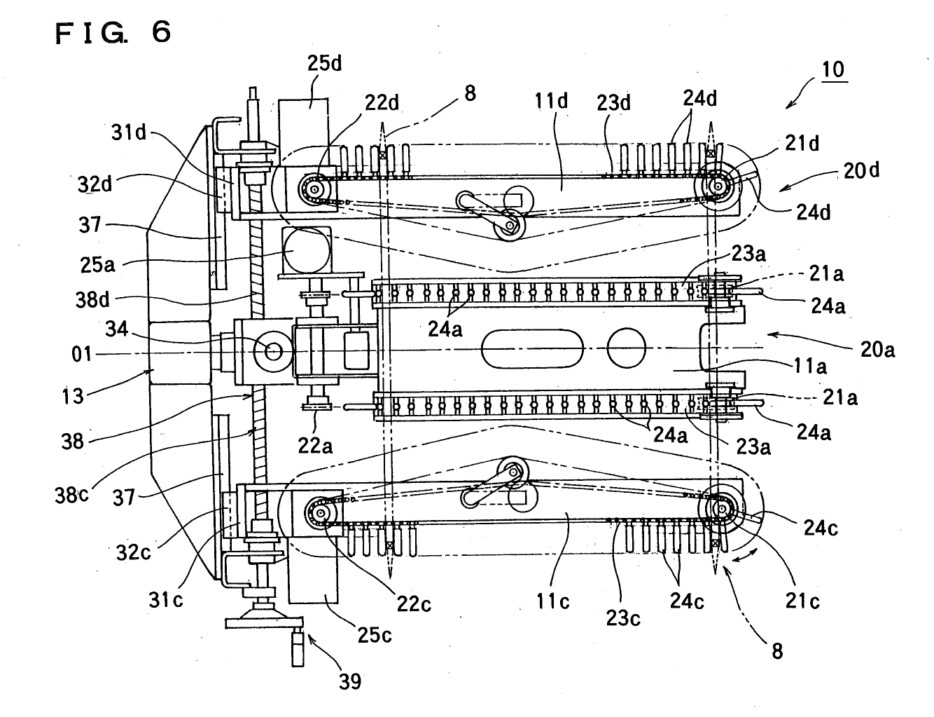

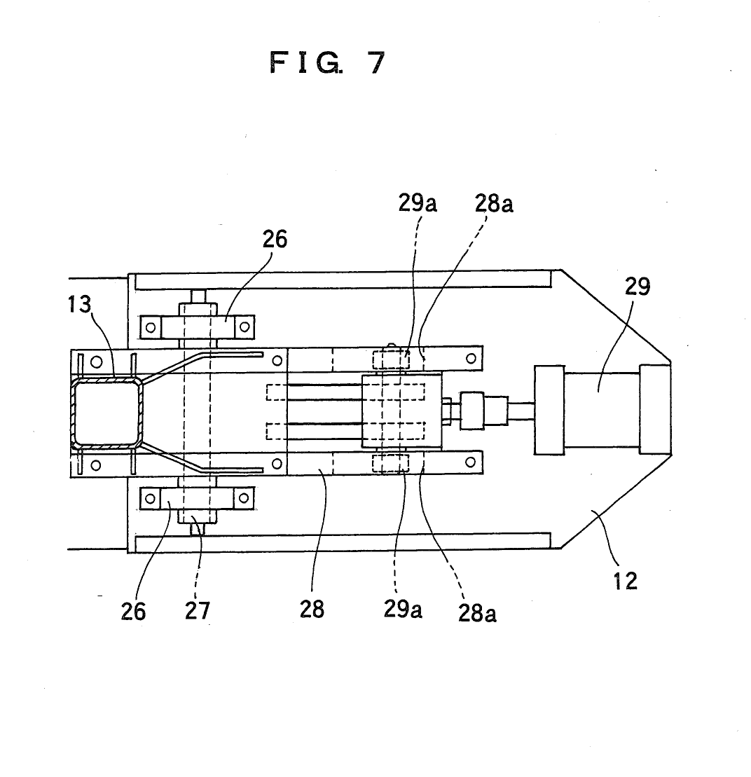

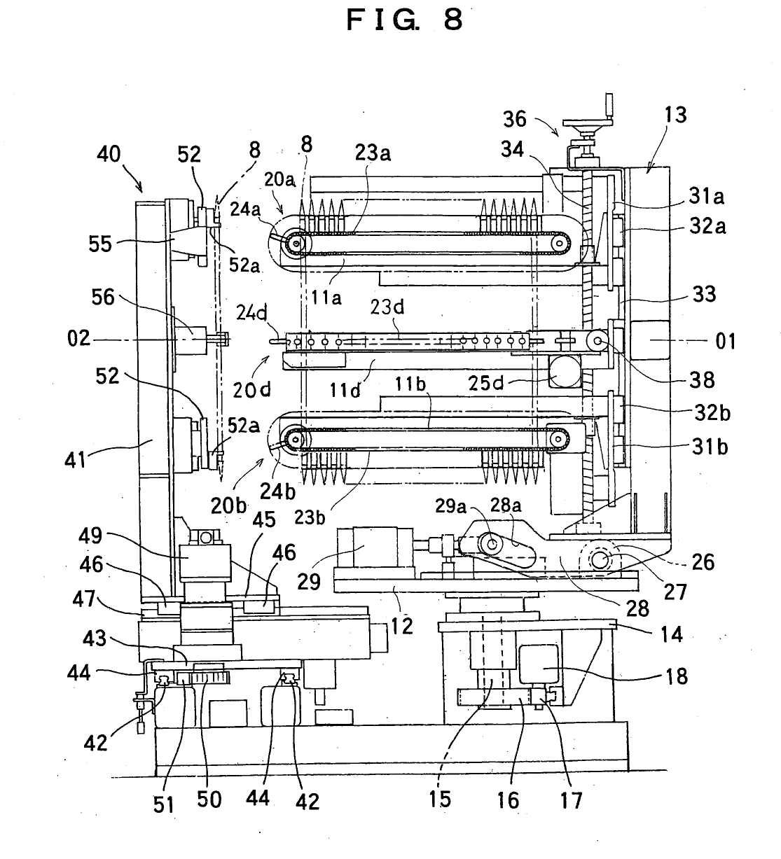

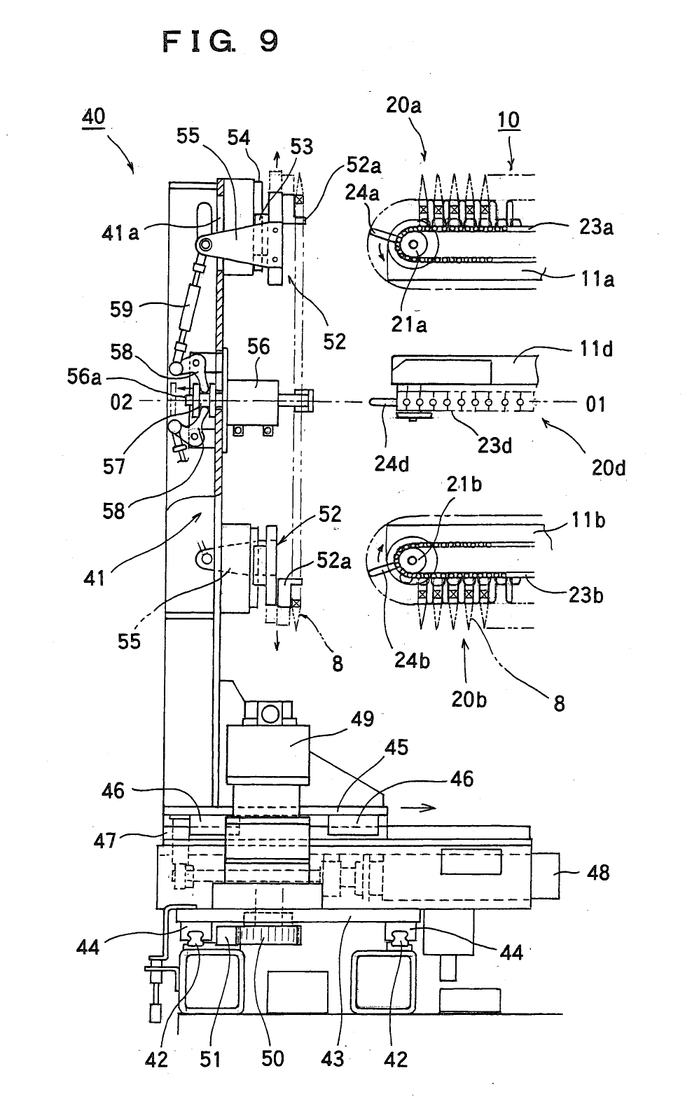

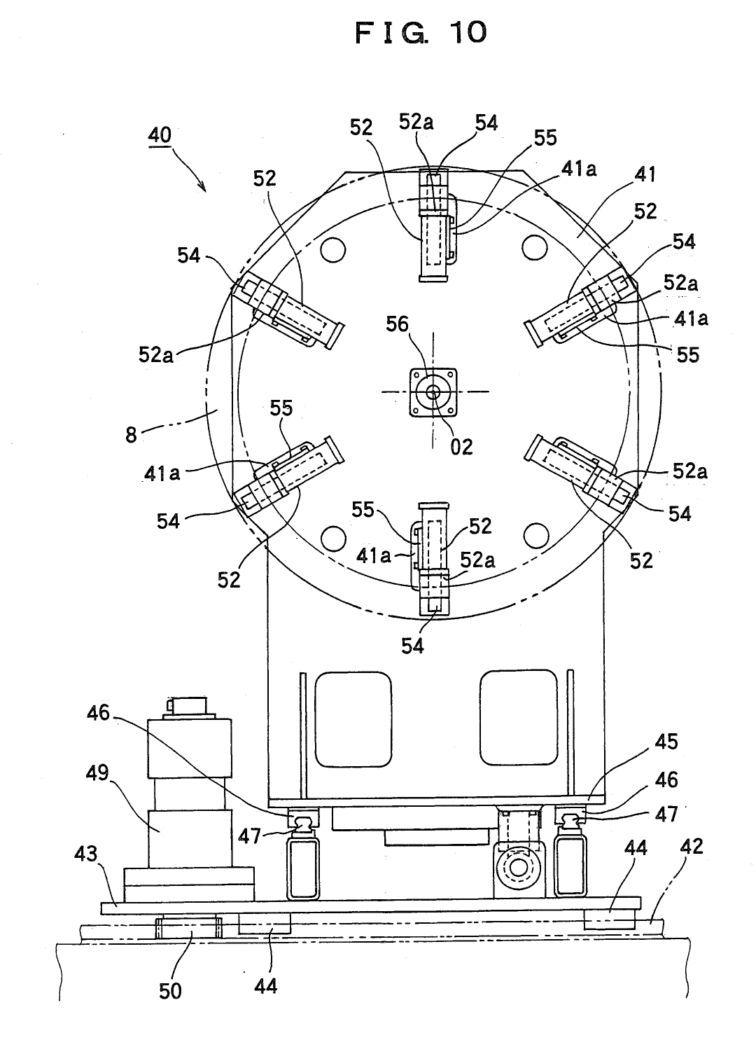

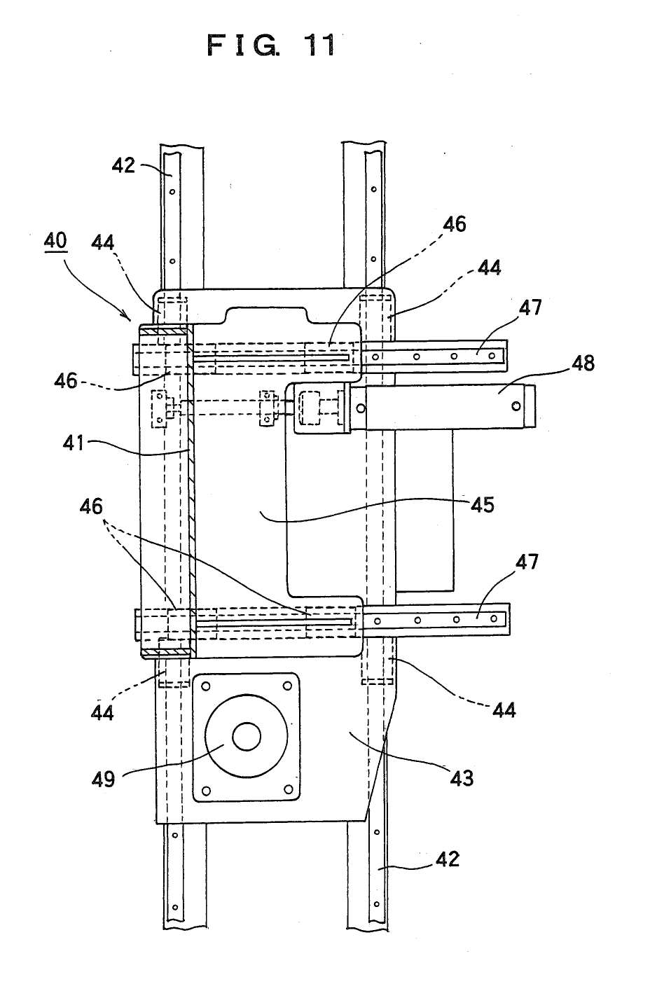

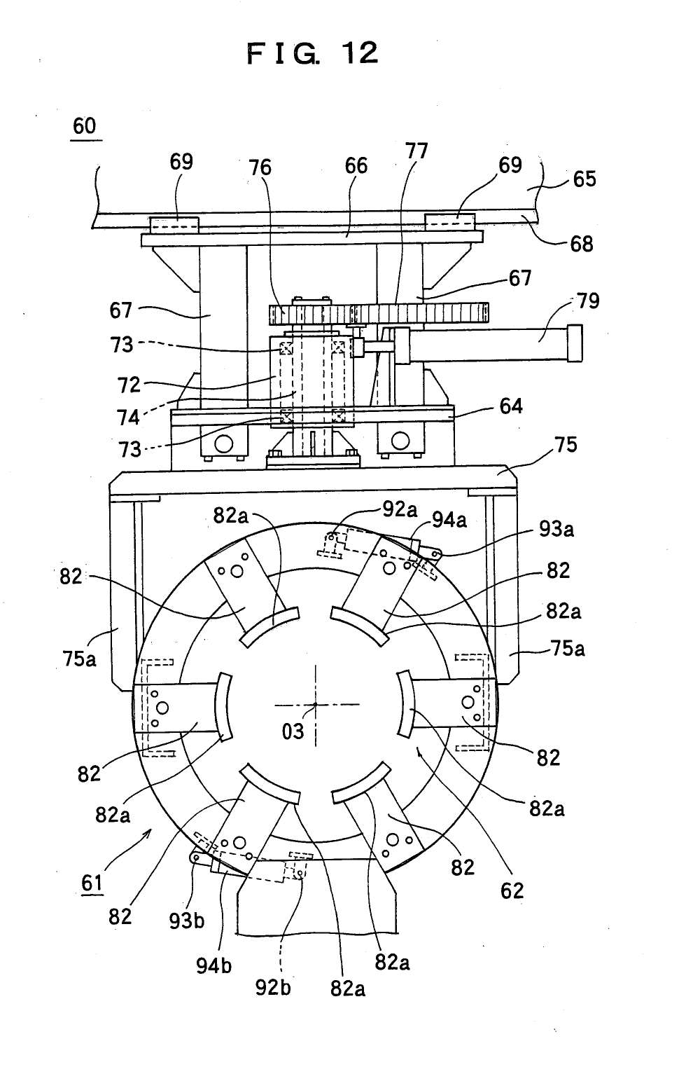

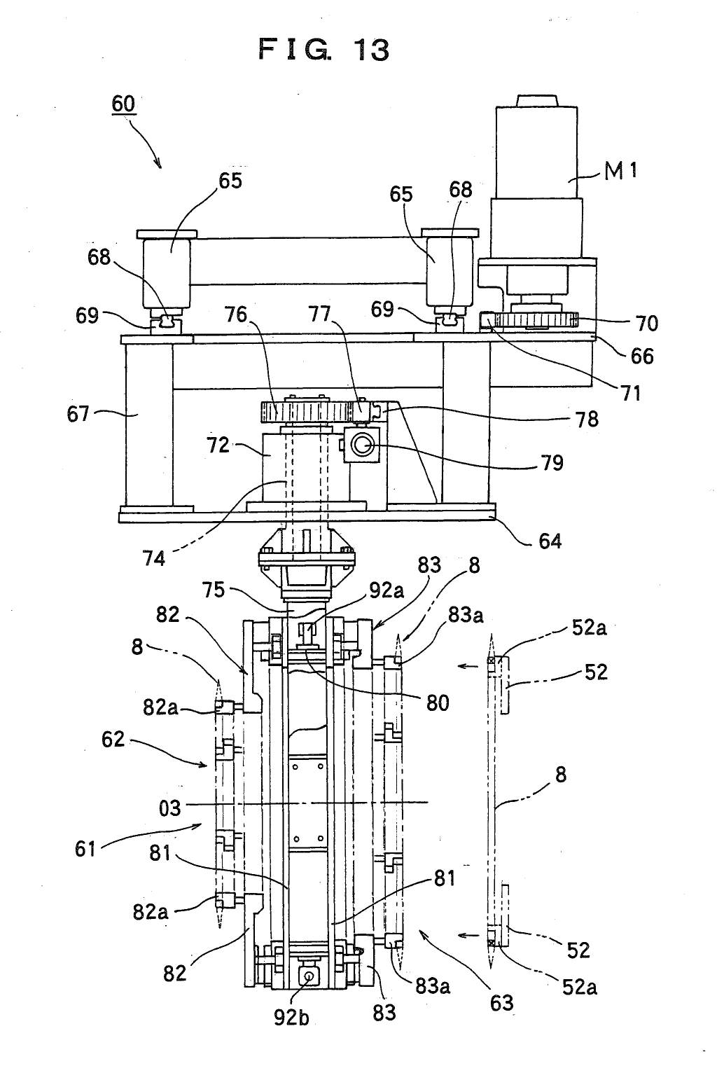

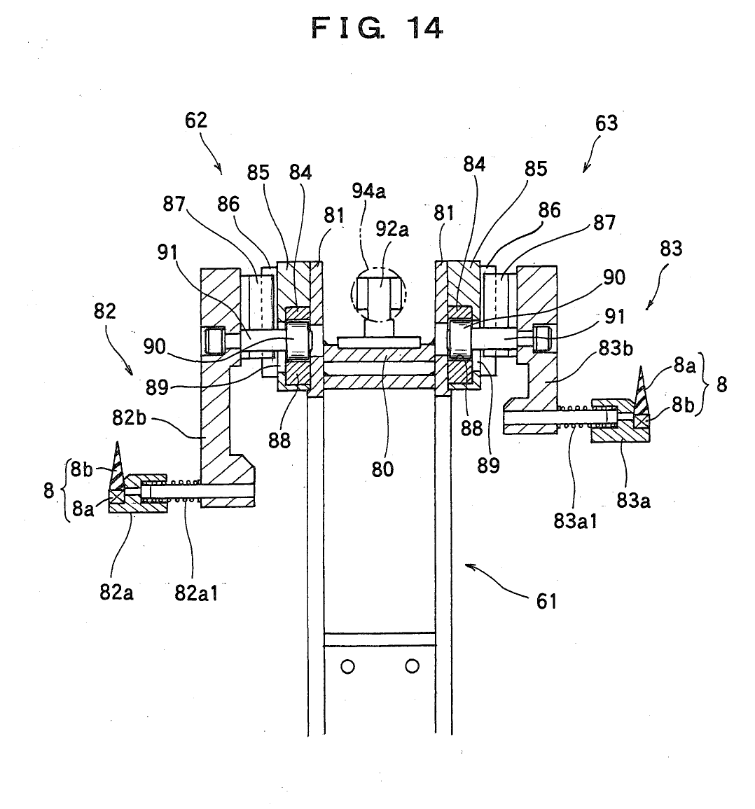

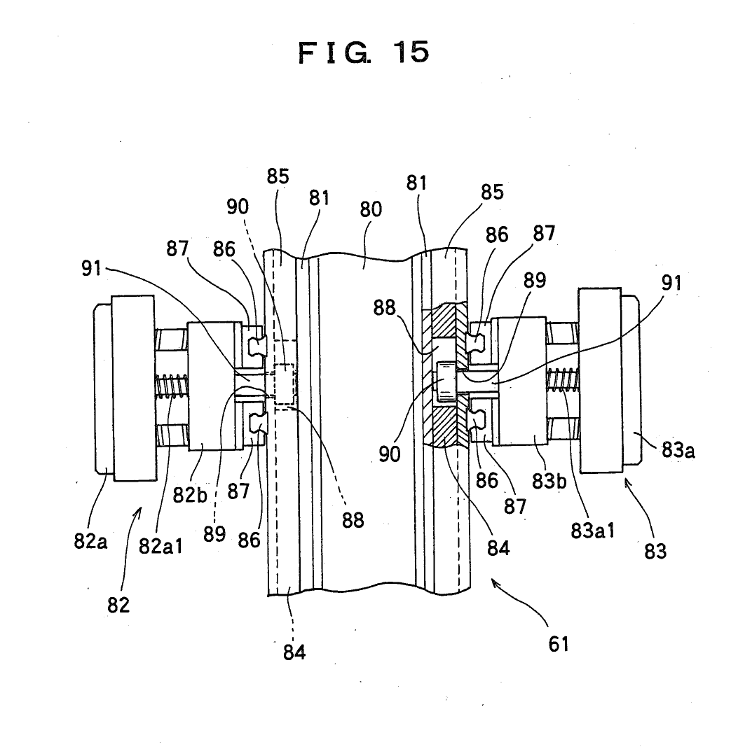

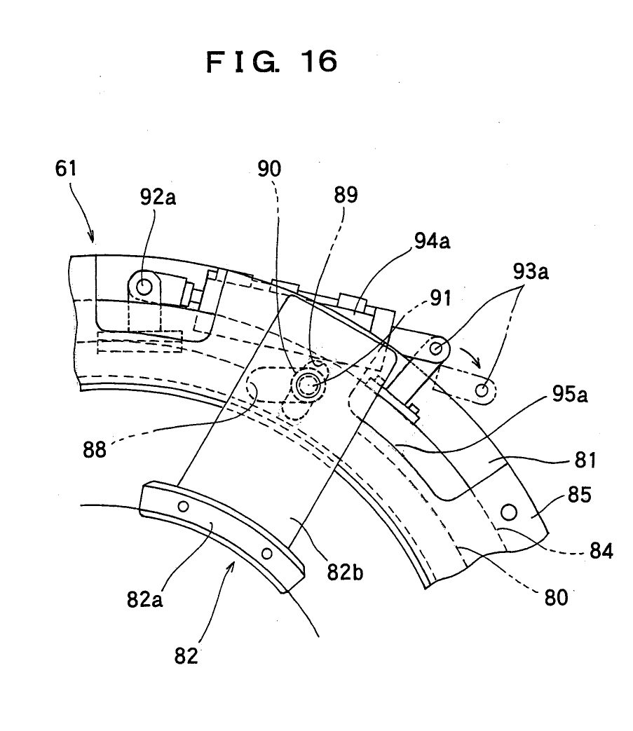

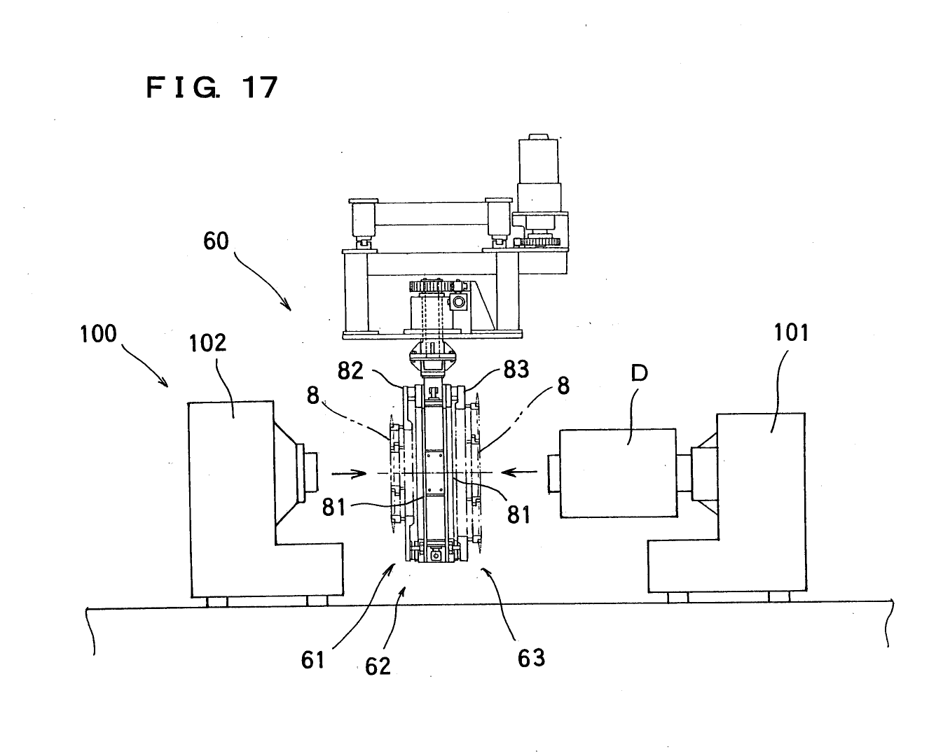

FIG. 1 is a schematic plan view showing schematically an overall bead supply system according to the invention in a tire building process, FIG. 2 is a side view as viewed from a direction which intersects at right angles an axial direction of a bead stocking unit and a bead transfer unit of the same bead supply system, FIG. 3 is an enlarged side view of the bead stocking unit, FIG. 4 is an enlarged view of part of the previous figure, FIG. 5 is a front view of the bead stocking unit as viewed from an open side thereof, FIG. 6 is a plan view of the bead stocking unit, FIG. 7 is a sectional view showing the construction of a supporting portion of the bead stocking unit, and FIG. 8 is a side view showing a state in which the open side of the bead stocking unit is directed to a side which confronts the bead transfer unit. FIG. 9 is a partially sectioned side view of the bead transfer unit, FIG. 10 is a front view of the bead transfer unit as viewed in an axial direction thereof, and FIG. 11 is a plan view showing a supporting construction of a main body portion of the bead transfer unit. FIG. 12 is a front view of a loading and setting unit as viewed from one side in an axial direction thereof, FIG. 13 is a side view of the loading and setting unit as viewed from a direction which intersects the axial direction at right angles, FIG. 14 is an enlarged sectional view of part, FIG. 15 is a plan view of the same part, FIG. 16 is a front view of part of the loading and setting unit which illustrates a displacement mechanism of a locking member in a radial direction, and FIG. 17 is a front view schematically showing a state of loading and setting on to a building machine.

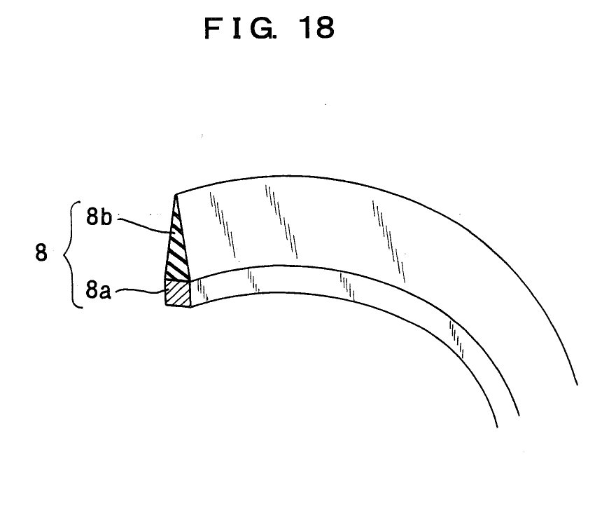

A bead supply system A of the invention is such as to supply an annular bead 8 like one shown in FIG. 18, that is, an annular bead 8 in which a filler rubber 8b having a substantially triangular cross section is added to an outer circumference of a bead core 8a such as a wire to a building machine in part of steps of a tire building process, in particular, bead setting and turning up steps, that is, to two supporting elements 101, 102 of a building machine 100 for performing bead setting and turning up steps by supporting a building drum D with the two supporting elements 101, 102 which confront each other for loading and setting thereonto and is configured as below.

In FIG. 1, 10 denotes a bead stocking unit which constitutes a supply unit of the beads 8 which are formed in advance in a different step and are loaded on a carriage or the like to be sent thereto, 40 a bead transfer unit for transferring the beads 8 one by one which are fed out from the bead stocking unit 10, and 60 a loading and setting unit of the beads 8 on to the building machine 100.

As is shown in FIGS. 2 to 7, the bead stocking unit 10 has a cantilevered supporting arm portion 11 which is supported horizontally at one end portion and which extends in one direction, so that a plurality of beads like the bead 8 can be locked on from inner circumferences thereof and held in alignment along the supporting arm portion 11 in such a manner as to be spaced apart at constant intervals with their axial centers oriented laterally and also has a transfer means 20 which can transfer the beads 8 so held intermittently at constant intervals towards an open end (a non-supported end) of the supporting arm portion 11. The holding height of the beads 8 is set to coincide with a holding height of the bead transfer unit 40, which will be described later.

In the bead stocking unit 10, the one end portion of the supporting arm portion 11 is fixed continuously to a supporting pillar 13 which is provided on a rotatable base table 12 in such a manner as to be erected therefrom and is supported horizontally, and the transfer means 20 is provided along the supporting arm portion 11.

As specific configurations of the supporting arm portion 11 supported on the supporting pillar 13 and the transfer means 20, in the case of an embodiment illustrated, the supporting pillar 13 is formed substantially into a cross shape as viewed from a front (the open end of the supporting arm portion) thereof, and supporting arm portions 11a, 11b and 11c, 11d, which are disposed upwards and downwards and leftwards and rightwards about the axial center O1 of the bead 8 which is held as described above and which extend in the horizontal direction in parallel with each other, are continuously fixed to the supporting pillar 13. A required number of beads like the bead 8 are locked and held along the upper and lower supporting arm portions 11a, 11b and the left and right supporting arm portions 11c, 11d from inner circumferences thereof in such a manner as to be spaced apart from each other on a concentric circle centered at the axial center O1, and transfer means 20a, 20b and 20c, 20d are provided for transferring the beads 8 so held at constant intervals towards respective distal end portions of the supporting arm portions.

As the upper and lower transfer means 20a, 20b, on both sides of the upper and lower supporting arm portions 11a, 11b, rotatable members 23a, 23b, which are made up of endless chains or the like and are adapted to rotate backwards and forwards, are extended between sprockets 21a, 22a; 21b, 22b which the upper and lower supporting arm portions 11a, 11b have at end portions at open ends (distal end portions) and end portions at proximal ends, and pins 24a, 24b are provided, respectively, on external sides of the rotatable members 23a, 23b in such a manner as to project therefrom for holding the beads 8 in such a manner as to be spaced apart from each other at constant intervals in a longitudinal direction. Thus, the beads 8 can be locked at two locations on each of upper and lower portions of their inner circumferences made up of the bead cores 8a by the rotatable members 23a, 23b and can be held in such a manner as to be spaced apart from each other at the constant intervals by the pins 24a, 24b.

In addition, as the left and right transfer means 20c, 20d, on a lower side of the supporting arm portion 11c with respect to one of them, for example, the left transfer means 20c, and on an upper side of the supporting arm portion 11d with respect to the right transfer means 20d, rotatable members 23c, 23d, which are made up of endless chains or the like and are adapted to rotate backwards and forwards, are extended between sprockets 21c, 22c; 21d, 22d which the left and right supporting arm portions 11c, 11d have at end portions at open ends (distal end portions) and end portions at proximal ends, and pins 24c, 24d are provided, respectively, on external sides of the rotatable members 23c, 23d in such a manner as to project therefrom for holding the beads 8 in such a manner as to be spaced apart from each other at constant intervals in a longitudinal direction (a moving direction for transfer). Thus, the beads 8 can be locked at left and right portions on the inner circumferences by the rotatable members 23c, 23d and can be held in such a manner as to be spaced apart from each other at the constant intervals by the pins 24c, 24d.

In such a state that respective external transfer portions of the upper and lower and left and right transfer means 20a, 20b, 20c, 20d are situated on a concentric circle centered at the axial center O1 and the respective pins 24a, 24b and 24c, 24d are held in the corresponding positions, the respective transfer means 20a, 20b, 20c, 20d are provided in such a manner as to rotate forwards and backwards in synchronism with each other by drive means 25a, 25b, 25c, 25d such as motors which are provided individually for the transfer means 20a, 20b, 20c, 20d. By this configuration, the beads 8 can be held in alignment at the upper and lower and left and right portions on the inner circumference thereof by the respective transfer means 20a, 20b, 20c, 20d in such a manner as to be spaced apart from each other and can be transferred intermittently at constant intervals arbitrarily in the forward or backward direction.

In particular, the transfer means 20a, 20b and 20c, 20d are provided in such a manner that the pins 24a, 24b and 24c, 24d turn while projecting from the distal ends of the supporting arm portions 11a, 11b and 11c, 11d at turning portions of the rotatable members 23a, 23b and 23c, 23d which are situated at the open-end end portions and are set such that through backward rotations of the external transfer portions in which the external transfer portions move from their open ends to proximal ends, that is, rotations from inwards to outwards at the turning portions, the bead 8 can be supplied to the respective pins 24a, 24b and 24c, 24d to be locked thereby, while through forward rotations of the external transfer portions in which the external transfer portions move from their proximal ends to open ends, that is, rotations from outwards to inwards at the turning portions, the beads 8 can be fed out intermittently one by one from the distal end portions. The transferring and feeding out actions by the transfer means 20a, 20b and 20c, 20d are performed intermittently in accordance with the transferring action by the bead transfer unit 40, which will be described later, or every time the bead transfer unit 40 is positioned to confront the bead stocking unit 10.

The diameter, space and projecting height of the respective pins 24a, 24b and 24c, 24d can be set as required in accordance with beads 8 to be held and space therebetween, however, for example, the diameter is set to be on the order of about 10 mm, and the space is set to be on the order of 20 mm. In addition, the projecting height of the respective pins 24a, 24b and 24c, 24d is set to be smaller than a radial dimension on the cross section of the bead 8. For example, the projecting height is set to be on the order of one third to a half the radial dimension.

In addition, with respect to the drive means for the respective upper and lower and left and right transfer means 20a, 20b and 20c, 20d, as with the illustrated embodiment, the drive means can be provided individually for the rotatable members of the respective transfer means. In addition to this, for example, the upper and lower transfer means 20a, 20b or the left and right transfer means 20c, 20d can be configured to be coupled together in such a manner as to be linked to each other, so that the transfer means so coupled can be rotated by one or two common drive means.

Additionally, the bead stocking unit 10 is provided in such a manner that the open-end end portion of the transfer means (20a, 20b, 20c, 20d) can be turned by rotating the base table 12 between a non-confronting side with the bead transfer unit 40, for example, a state in which the open-end end portions are turned through 180° from a confronting side with the bead transfer unit 40 (refer to FIG. 2) and a state in which the open-end portions are directed towards the confronting side with the bead transfer unit 40 (refer to FIG. 8), whereby a predetermined number of beads 8 are locked in parallel on the transfer means 20 on the opposite side of the bead stocking unit 10 to the confronting side with the bead transfer unit 40, and thereafter, the distal end portion of the transfer means 20 can be directed towards the confronting side with the bead transfer unit 40.

As a means for rotating the base table 12, the base table 12 is installed rotatably on a fixed table 14 which lies therebelow, and a gear wheel 16 is provided on a portion of a shaft portion 15 which is fixed continuously to a lower surface of the base table 12 to extend downwards while passing through the fixed table 14, a rack 17 which meshes with the gear wheel 16 being provided in such a manner as to move back and forth in a longitudinal direction through operation of a cylinder unit 18 coupled thereto, the base table 12 thereby being made to rotate through a predetermined angle in the way described above.

In addition, in the case of the illustrated embodiment, the supporting pillar 13 is rotatably supported by a horizontal supporting shaft 27 which is supported by bearings 26, 26 on the base table 12, and a cylinder unit 29 is engaged with and coupled to supporting plates 28, 28 which are annexed to both sides of a lower end portion of the supporting pillar 13, whereby when the cylinder unit 29 is not in operation, lower ends of the supporting plates 28, 28 are brought into contact with an upper surface of the base table 12 in a confronting fashion so that the supporting pillar 13 is held in an erected state, while the supporting pillar 13 is made to be tilted to the rear through operation of the cylinder unit 29, thereby making it possible to facilitate a bead locking operation by tilting the supporting pillar 13 which supports the transfer means 20 when locking a bead 8 on the transfer means 20. In the case of the illustrated embodiment, engaging members 29a that the cylinder unit 29 has at an end portion of an output shaft thereof are brought into engagement with oblique elongated holes 28a formed in the supporting plates 28, whereby the supporting pillar 13 is made to be tilted together with the supporting arm portion and the transfer means by tilting the supporting plates 28 through the forward and backward operation of the output shaft.

Furthermore, guides 32a, 32b which are annexed to mounting plates 31a, 31b at rear ends of the upper and lower supporting arm portions 11a, 11b are brought into engagement with a vertical guide rail 33 provided on a front surface of the supporting pillar 13, whereby the upper and lower supporting arms 11a, 11b are supported in such a manner as to be moved vertically. In addition, a threaded shaft 34, on upper and lower portions of which threads which are inverse to each other are formed, passes vertically through the rear end portions of both the supporting arm portions 11a, 11b, and upper and lower inversely threaded portions 34a, 34b are thread fitted in threaded hole portions 35a, 35, respectively, which are provided on part of both the supporting arm portions 11a, 11b, respectively, whereby both the supporting arm portions 11a, 11b are provided in such a manner as to be moved vertically in directions in which they approach and move away from each other by operating rotationally a handle 36 continuously fixed to an end portion of the threaded shaft 34.

Guides 32c, 32d which are annexed to mounting plates 31c, 31d at rear ends of the left and right supporting arm portions 11c, 11d are brought into engagement with a horizontal guide rail 37 provided on the front surface of the supporting pillar 13, whereby the left and right supporting arms 11c, 11d are also supported in such a manner as to be moved horizontally. In addition, a threaded shaft 38, on left and right portions of which threads which are inverse to each other are formed, passes horizontally through the rear end portions of both the supporting arm portions 11c, 11d, and left and right inversely threaded portions 38c, 38d are thread fitted in threaded hole portions 35c, 35d, respectively, which are provided on part of both the supporting arm portions 11c, 11d, respectively, whereby both the supporting arm portions 11c, 11d are provided in such a manner as to be moved horizontally in directions in which they approach and move away from each other by operating rotationally a handle 39 continuously fixed to an end portion of the threaded shaft 38.

By this configuration, spaces between the upper and lower and left and right transfer means 20a, 20b and 20c, 20d which are provided, respectively, on the supporting arm portions 11a, 11b and 11c, 11d are made to be adjusted as required in accordance with diameters of beads 8 to be locked.

Although the bead stocking unit 10 that is configured as has been described heretofore may be provided one, in the case of the illustrated embodiment, as is shown in FIG. 1, two bead stocking units 10 which are configured as has been described above are provided in parallel, whereby while beads are transferred from one of the bead stocking unit 10 to the bead transfer unit 40, which will be described later, new beads 8 are made to be locked and held on the other bead stocking unit 10 in such a manner as to be spaced apart from each other at constant intervals. Namely, the bead supply operation can be implemented without stopping the operation of the building machine.

In addition, by providing the two bead stocking units 10, when switching tires to be built, since, while current beads are being fed out from one of the bead stocking units 10, beads which replace the current ones can be locked and held on the other bead stocking unit 10, the switching operations of tires to be built can be performed while continuously operating the building machine.

The bead transfer unit 40 is configured as is shown in FIGS. 9 to 11 and includes on a front surface of a main body portion 41 thereof which constitutes a confronting side with the bead stocking unit 10 a holding means, which will be described later, for receiving the beads 8 one by one from the distal end portion of the transfer means 20 (20a, 20b, 20c, 20d) in a confronting position with the bead stocking unit 10 and holding the beads so received thereon. The bead transfer unit 40 is installed on a base table 43 which can move on rails 42 which extend from the confronting position with the bead stocking unit 10 to a loading waiting position P1 on to the building machine 100, which will be described later, in such a manner as to move from the confronting position with the bead stocking unit 10 to the loading waiting position P1. The base table 43 is installed movably by guides 44 annexed to a lower surface thereof being brought into engagement with the rails 42.

In addition, a mounting support plate 45 is fixedly provided at a lower end of the main body portion 41 of the bead transfer unit 40, and guides 46 annexed to a lower surface of the mounting support plate 45 are brought into engagement with guide rails 47 which are provided on the base table 43 in a direction which intersects the rails 42 at right angles, whereby the bead transfer unit 40 is provided in such a manner as to move in a direction in which it approaches the distal end portion of the transfer means 20 in a position where it confronts, for example, the distal end portion of the transfer means 20 (20a, 20b, 20c, 20d) of the bead stocking unit 10. 48 denotes an actuator such as a linear guide which functions as a drive means for the movement of the bead transfer unit 40.

As a moving means for the base table 43, a driving motor 49 is installed on the base table 43 with its axial center oriented vertically, and a gear wheel 50 is fixedly provided on a portion of an output shaft of the motor 49 which projects downwards of the base table 43. The gear wheel 50 meshes with a rack 51 which is provided along the rail 42, whereby the base table 43 is provided in such a manner as to move along the rack 51 through rotation of the gear wheel 50 through, in turn, operation of the motor 49 so that the bead transfer unit 40 can be reciprocated between the confronting position with the bead stocking unit 10 and the loading waiting position P1.

In the bead transfer unit 40, as the holding means for the bead 8, a plurality of locking members 52 each having a locking stepped portion 52a which can be locked on an inner circumferential edge of the bead 8 are provided on the front surface of the main body portion 41, that is, the front surface which constitutes a confronting side with the distal end portion of the transfer means 20 of the bead stocking unit 10 in such a manner as to be displaced in a radial direction (as diverging in lines from a common center) in synchronism with each other in positions spaced apart from each other in a circumferential direction at equal angular intervals relative to an axial center O2 which coincides with the axial center O1 of the bead stocking unit 10 when receiving the bead 8, so that the bead 8 can be received to be held by the locking members 52. There may be a case where a magnet (not shown) which can implement magnetic attraction is provided on the locking stepped portion 52a as required for ensuring the reception of the bead 8.

In the case of the illustrated example, a guide 53 which is provided on a back surface of each of the locking members 52 is brought into engagement with a radial guide 54 on the front surface of the main body portion 41, whereby the locking member 52 is held in such a manner as to be displaced. As means for displacing each of the locking members 52 in the radial direction, a lever 55 which is provided on each of the locking members 52 in such a manner as to project rearwards in an axial direction of the main body portion 41 is fitted in an elongated hole 41a in the main body portion 41 which extends in such a manner as to diverge in line from the axial center O2 of the main body portion 41 so as to be displaced therein in the axial direction to thereby be made to project to a back side of the main body portion 41. In addition, a cylinder unit 56 is provided in a central portion of the main body portion 41, and a circumferential recessed groove member 57 is provided on an outer circumference of an output shaft 56a of the cylinder unit 56 which moves back and forth. L-shaped arm members 58 which engage with the recessed groove member 57 are rotatably supported on the output shaft 56a, and one end portion of the arm member 58 and the lever 55 are coupled together via connecting member 59 whose length can be adjusted, whereby the respective locking members 52 can be displaced in the radial direction by the recessed groove member 57 being moved back and forth through operation of the cylinder unit 56. By this configuration, when receiving the bead 8, with the locking members 52 held so that the circumscribed circle of the locking stepped portions 52a is made smaller than the inside diameter of the bead 8, in such a state that the locking stepped portions 52a of the locking members 52 have entered the interior of the bead 8, the locking members 52 are displaced radially in a direction in which the diameter of the circumscribed circle is increased, whereby the bead 8 is made to be locked and held from the inside thereof.

In addition, the loading and setting unit 60 is provided in such a manner as to confront in the loading waiting position P1 the bead transfer unit 40 which comes to the position in question so as to receive and hold the bead 8 from the bead transfer unit 40 and is constructed as is shown in FIGS. 12 to 16.

Namely, the loading and setting unit 60 has holding means 62, 63 which are provided on both axial surfaces of an annular main body portion 61 for receiving and holding the bead 8 from the bead transfer unit 40, and the main body portion 61 is supported in such a manner as to be turned relative to a supporting base plate 64 so that the holding means 62, 63 are directed alternately to a confronting side with the bead transfer unit 40, whereby beads 8 which are transferred by the bead transfer unit 40 in the way described above can be received alternately to be held by the holding means 62, 63. In addition, because of this, the main body portion 61 is supported at a height in which an axial center O3 of the main body portion 61 coincides with the axial center O2 in such a state that the main body portion 61 confronts the bead transfer unit 40.

The loading and setting unit 60 can move between the loading waiting position P1 and a loading and setting position P2 where the loading and setting unit 60 confronts both the supporting elements 101, 102 of the building machine 100, and is provided in such a manner as to move to the loading and setting position P2 where it confronts both the supporting elements 101, 102 of the building machine 100 with beads 8, 8 held on both the holding means 62, 63 as has been described above. By this configuration, by a single movement of the loading and setting unit 60 to the loading and setting position P2 with the beads 8 held on both the surfaces thereof, respectively, the beads 8 can be supplied to both the supporting elements 101, 102 for loading and setting thereonto.

As means for moving the loading and setting unit 60 between the loading waiting position P1 and the loading and setting position P2, in the case of the illustrated embodiment, the following configuration is adopted.

A movable table plate 66, which can move along two supporting frames 65 which are provided to extend horizontally in parallel with the moving direction, is provided above the unit, and the supporting base plate 64 which supports the main body portion 63 is coupled to the movable table plate 66 by coupling support members 67 in such a manner as to be supported in a suspended state. Moving guide rails 68 are fixedly provided, respectively, on lower surfaces of the supporting frames 65, and the movable table plate 66 is movably supported by guides 69 fixed to an upper surface thereof being brought into engagement with the guide rails 68, respectively. In addition, a moving motor M1 is installed on the movable table plate 66, and a gear wheel 70 on an output shaft of the motor M1 is made to mesh with a rack 71 fixedly provided along the supporting frame 65, whereby the movable table plate 66 is provided in such a manner as to move along the supporting frames 65 via the rack 71.

In addition, as means for supporting the main body portion 61 in such a manner as to be turned, in the case of the illustrated embodiment, the means in question is configured as follows.

A supporting tube 72 is provided in a central portion of the supporting base plate 64 in such a manner as to pass therethrough vertically, and a supporting shaft 74, which is rotatably supported by a bearing 73 fittingly provided inside the supporting tube 72, is provided in such a manner as to pass therethrough vertically. A substantially inverted U-shape frame member 75 for supporting the main body portion 61 is mounted on a lower end portion of the supporting shaft 74 which projects downwards from the supporting tube 72, and a gear wheel 76 is mounted on an upper end portion of the supporting shaft 74 which projects upwards from the supporting tube 72. A rack 77, which can move in a longitudinal direction along a horizontal guide member 78 which is provided on the supporting base plate 64, meshes with the gear wheel 76, and an output shaft of a cylinder unit 79 provided on the supporting base plate 64 is coupled to the rack 77, whereby by the rack 77 being caused to move back and forth by virtue of operation of the cylinder unit 79, the supporting shaft 74 rotates together with the gear wheel 76, so that the main body portion 61 is made to be turned. The turning angle of the main body portion 61 can be set as required based on a distance over which the rack 77 moves back and forth. Thus, as has been described above, the turning angle is set such that the main body portion 61 is turned through 180° so that both the front and rear surfaces of the main body portion 61, that is, the holding means 62, 63 are directed alternately towards the confronting side with the bead transfer unit 40.

The main body portion 61 is made up of a tubular barrel portion 80 which opens in the axial direction and mounting plates 81, 81 which are welded integrally to axial end portions of the barrel portion 80, respectively in such a manner as to projects in a radial direction in a flange-like fashion, and both end portions 75a, 75a of the frame member 75 are coupled to both left and right side portions which intersect the axial direction of the barrel portion 80 at right angles to be supported thereon.

As the holding means 62, 63 on both the axial surfaces, a plurality of locking members 82, 83 having, respectively, locking stepped portions 82a, 83a which can be locked on the inner circumferential edge of the bead 8 are provided in positions spaced apart at equal angular intervals in the circumferential direction relative to the axial center O3, in particular, in positions which do not coincide with the locking members 52 of the bead transfer unit 40 in such a manner as to be displaced in a radial direction (as diverging in lines from the common center), whereby the locking members 82, 83 are provided to lock the bead 8 through their displacement actions. In the case of the illustrated embodiment, the locking stepped portions 82a, 83a are made up of members which are different from main body portions 82b, 83b of the locking members 82, 83 and are mounted on the main body portions 82b, 83b in such a manner as to be elastically displaced therefrom via spring means 82a1, 83a1. By this configuration, impact is made to be mitigated which would be generated by contact made when receiving a bead 8 from the locking members 52 of the bead transfer unit 40, or when setting a bead 8 on to both the supporting elements 101, 102 of the building machine 100.

As means for displacing the locking members 82, 83 in the radial direction, in the case of the illustrated embodiment, the means include the following configurations, respectively.

A ring-shaped holding plate 85 is fixed on an external side of each of the mounting plates 81, 81 which holds an annular disc-shaped movable plate 84 between the mounting plate 81 and itself in such a manner as to rotate in a circumferential direction. Pairs of radially parallel guide rails 86 are mounted on an axial external surface of the holding plate 85 at intervals equal to the intervals at which the locking members 82, 83 are disposed, and guides 87 which are annexed to rear surfaces of the locking members 82, 83 are brought into sliding engagement with the guide rails 86.

In addition, elongated inclined holes 88 which are inclined relative to tangents to a circle centered at the axial center O3 of the main body portion 61 are formed on the movable plate 84 at intervals equal to the intervals at which the locking members 82, 83 are disposed, and radial elongated holes 89 are formed on the holding plate 85 in positions corresponding to the inclined holes 88 which are located at intervals equal to the intervals at which the locking members 82, 83 are disposed and in position.

Displacement guiding rollers 90 are mounted, respectively, on the locking members 82, 83 via shaft members 91 which are provided on back surfaces of the main body portions 82b, 83b in such a manner as to project therefrom, and the shaft members 91 pass through the elongated holes 89 in such a manner as to be displaced in a longitudinal direction (a radial direction), whereby the rollers 90 are made to fit rollingly in the inclined holes 88. By this configuration, by the rotatable plate 84 rotating in the circumferential direction relative to the holding plate 85, the rollers 90 are displaced in the radial direction due to the inclination of the inclined holes 88, and the shaft members 91 are displaced in the radial direction within the elongated holes 89, whereby the locking members 82, 83 are each provided in such a manner as to be displaced in the radial direction.

Namely, by rotatably displacing the movable plates 84, 84 on both the sides in the circumferential direction, as has been described above, the respective locking members 82, 83 on both the sides are each made to be displaced in the radial direction.

As means for rotatably displacing the movable plates 84, 84 in the circumferential direction, the means have the following configuration. A cylinder unit 94a is interposed between a rotatably supporting member 92a which is provided on part of an outer circumference of the tubular barrel portion 80 of the main body portion 61 in such a manner as to project therefrom and a coupling member 93a which is coupled to the movable plate 84 lying on the side of one of the locking members, that is, on the locking member 82 through a cut-out portion 95a which is provided in part of the holding plate 85 or the mounting plate 81, and a cylinder unit 94b is interposed between the other rotatable supporting member 92b which is provided on part of the outer circumference of the tubular barrel portion 80 in such a manner as to project therefrom and a coupling member 93b coupled to the movable plate 84 lying on the side of the other locking member 83 through a cut-out portion provided part of the holding plate 85 or the mounting plate 81, whereby by both the cylinder units 94a, 94b moving back and forth, the movable plates 84, 84 are provided in such a manner as to rotate to be displaced individually and separately relative to the fixed tubular barrel portion 80, that is, the mounting plates 81. Both the cylinder units 94a, 94b are controlled as required when a bead is received from the bead transfer unit 40 and the bead so received is transferred on to the building machine 100 in the loading and setting position P2.

Note that while in FIGS. 12 to 14, as to the respective locking members 82, 83 as the holding means 62, 63 provided on both the axial sides of the main body portion 61, the main body portions 82b, 83b are illustrated as being different in length and the locking stepped portions 82a, 83a which lock the bead 8 are illustrated as being positioned differently, this indicates that locking members 82, 83 are replaced to those which correspond to the inside diameter of beads 8 to be supplied, and in an actual bead supply operation, normally, as locking members 82, 83 on both the sides, locking members are used which hold beads 8 of the same diameter. Of course, depending upon types of tires to be built, there may be a case where a bead supply operation is carried out with beads 8, 8 having different diameters made to be held by the locking members 82, 83 on both the sides. In this case, beads having different diameters are stocked on the two bead stocking units 10, 10, and both the beads are transferred alternately by the bead transfer unit 40, so as to be locked and held on the locking members 82, 83 on both the sides.

To describe an operating condition of the bead supply system, in the bead stocking unit 10, with the open-end end portions of the upper and lower and left and right transfer means 20a, 20b, 20c, 20d which are provided along the upper and lower and left and right supporting arm portions 11a, 11b, 11c, 11d directed towards the non-confronting side with the bead transfer unit 40, while the respective transfer means 20 (20a, 20b, 20c, 20d) are made to rotate reversely at predetermined intervals, preferably, rotated intermittently at the turning portions at the open-end end portions, a bead 8 to be supplied is locked between the respective pins 24a, 24b and 24c, 24d which are provided at the constant intervals on the transfer means 20, so that a required number of beads 8 are held in parallel while being spaced apart from each other at the constant intervals on the bead stocking unit 10 (FIG. 2). By this action, since the beads 8 are supported from their inner circumferences where the bead cores reside and are held spaced apart from each other, there is no fear that the filler rubbers 8b of the beads 8 get bonded to each other or deformation is generated therein while they are stocked or transferred.

Then, by the base table 12 being rotated through operation of the cylinder unit 18, the bead stocking unit 10 on which the required number of beads 8 are held is turned through 180°, and the open-end end portions of the transfer means 20 (20a, 20b, 20c, 20d) are directed towards the confronting side with the bead transfer unit 40 (FIG. 8).

Then, when the bead transfer unit 40 has moved to arrive at the confronting position which the bead stocking unit 10, the main body portion 41 thereof moves forwards in a direction in which it approaches the distal end portion of the transfer means 20 of the bead stocking unit 10 or the turning portion of the rotatable member 23 (23a, 23b, 23c, 23d). At the same time as this occurs, the transfer means 20 (20a, 20b, 20c, 20d) of the bead stocking unit 10 performs a transfer in accordance with a length equal to the intervals at which the respective pins 24a, 24b, 24c, 24d are provided on the transfer means 20 in such a manner as to project therefrom by virtue of rotation of the rotatable member 23, and the respective pins 24a, 24b, 24c, 24d that the transfer means 20 possesses rotate from outwards to inwards at the turning portion and stop in a predetermined inclined position, whereby the bead 8 is held in such a manner as to be released from the transfer means 20.

In this state, the plurality of locking members 52, provided at the front surface of the main body portion 41 of the bead transfer unit, which has approached to arrive at the turning portion of the transfer means 20 in the way described above, enter the interior of the bead 8 and are displaced radially outwards via the L-shaped arm members 58 and the levers 55 by virtue of operation of the cylinder unit 56, whereby the locking stepped portions 52a of the locking members 52 come to be locked on the inner circumferential edge of the bead 8, which is thus held from the inside thereof by the locking members 52. At this time, the bead 8 is held on the locking stepped portions 52a by means of a magnetic attraction means according to need.

After the main body portion 41 has returned to its original position, the bead transfer unit 40 which is holding one bead 8 in the way described above moves along the rails 42 to the loading waiting position P1 on to the building machine 100 by the motor 49 being driven and then confronts one axial side of the main body portion 61 of the loading and setting unit 60 provided at the loading waiting position P1 (a chain line in FIG. 14). In this confronting state, the main body portion 41 of the bead transfer unit 40 moves forwards towards the side of the main body portion 61 of the loading and setting unit 60 with the bead 8 kept held by the locking members 52, so that the bead 8 is fed into a position where the bead 8 can be locked by the holding means 62 (or 63) that the main body portion 61 possesses.

As this occurs, the locking stepped portions 82a (or 83a) of the locking members 82 (or 83) which make up the holding means 62 (or 63) that the main body portion 61 of the loading and setting unit 60 possesses are in such a state that they reside within the inside diameter of the bead 8, and the bead 8 that is fed in by the main body portion 41 moving forwards is positioned outwards of the locking stepped portions 82a (or 83a). In this state, by the movable plate 84 on the side of locking members 82 (or 83) rotating by virtue of operation of the cylinder unit 94a (or 94b) which is interposed between the tubular barrel portion 80 and the movable plate 84 of the main body portion 61, the locking members 82 (or 83) are displaced radially outwards so as to be locked on the inner circumferential edge of the bead 8, and at the same time as this occurs, the locking members 52 of the bead transfer unit 40 are displaced radially inwards so as to be released from the bead 8, the main body portion 41 returning to its original position, whereby the bead 8 is transferred from the bead transfer unit 40 to the holding means 62 (or 63) on one of the front and back sides of the main body portion 61 of the loading and setting unit 60.

When the reception of the bead 8 by the holding means 62 (or 63) on the one side is completed, the bead transfer unit 40 moves to the confronting position with the bead stocking unit 10, so as to receive and hold one bead 8 from the bead stocking unit 10 by the locking members 52 in a similar manner to what has been described above.

In addition, as to the main body portion 61 of the loading and setting unit 60, the main body portion 61 turns 180° by the supporting shaft 74 rotating via the rack 77, which moves back and forth through operation of the cylinder unit 79 provided thereabove, and the gear wheel 76, whereby the other side of the front and back sides in the axial direction is directed towards the confronting side with the bead transfer unit 40. Thereafter, the bead transfer unit 40 moves to the confronting position with the loading and setting unit 60 with a bead 8 held thereon, so that the bead 8 is made to be received and held on the holding member 63 (or 62) on the other side of the main body portion 61 of the loading and setting unit 60 which confronts the main body portion 41 of the bead transfer unit 40 in the same manner as what has been described above.

Thus, when the loading and setting unit 60 completes the holding of the beads 8, 8 by the holding means 62, 63 which are provided on both the axial sides of the main body portion 61 thereof, the movable table plate 66 coupled to the supporting base plate 64 of the loading and setting unit 60 moves to the loading and setting position P2 which confronts both the supporting elements 101, 102 of the building machine 100 by virtue of operation of the moving motor M1 installed on the movable table plate 66 (FIG. 17), whereby the beads 8, 8 are held in such a state that they can be supplied to both the supporting elements 101, 102.

As this occurs, in the loading and setting position P2, with the building drum D supported by either of the supporting elements, for example, by the supporting element 101 of the building machine 100, both the supporting elements 101, 102 are in such a state that they are spaced away from the loading and setting position P2, and after the loading and setting unit 60 has moved to the loading and setting position P2 as described above, both the supporting elements 101, 102 enter alternately the main body portion 61 of the loading and setting unit 60, and at the same time, the locking members 82 or 83 as the holding means are displaced radially inwards so as to release the bead holding action, whereby the beads 8, 8 are made to be held in predetermined positions on both the supporting elements 101, 102, respectively. Thereafter, the loading and setting unit 60 is returned to its original position, so as to hold beads 8 transferred by the bead transfer unit 40 on the front and back sides in the axial direction in the similar manner to what has been described above.

In addition, in the building machine 100, after the beads 8, 8 have been held thereon in the way described above, predetermined building operations such as bead setting and tuning up operations are performed. For example, the reception of a tubular carcass band by the building drum D, bead setting and tuning up with the building drum D supported by both the supporting elements 101, 102, bonding of a pad underneath a belt and the like are performed. Thereafter, the two supporting elements 101, 102 are separated apart from each other, and a built green casing is removed from the building drum D to be sent to the following building steps, whereafter, the two supporting elements 101, 102 wait in such a state that they are separated on both sides of the loading and setting position P2.

By repeating the operations described above, the annular beads can automatically be supplied and set on to the building machine which supports the building drum in accordance with the tire building cycle.

Note that operations of the respective constituent portions of the bead stocking unit 10, the respective constituent portions of the bead transfer unit 40 and the respective constituent portions of the loading and setting unit 60 are controlled such that the bead supplying operations are performed continuously in association with each other.

### INDUSTRIAL APPLICABILITY

The invention can preferably be applied to the automatic supply of annular beads which act as reinforcement members to the building machine in the bead setting and turning up steps in the tire building process.

### BRIEF DESCRIPTION OF THE DRAWINGS

[FIG. 1] A schematic plan view showing schematically an overall bead supply system according to the invention.

[FIG. 2] A side view as viewed from a direction which intersects at right angles an axial direction of a bead stocking unit and a bead transfer unit of the same bead supply system.

[FIG. 3] An enlarged side view of the bead stocking unit.

[FIG. 4] An enlarged view of part of the previous figure.

[FIG. 5] A front view of the bead stocking unit as viewed from an open side thereof.

[FIG. 6] A plan view of the bead stocking unit.

[FIG. 7] A sectional view showing the construction of a supporting portion of the bead stocking unit.

[FIG. 8] A side view showing a state in which the open side of the bead stocking unit is directed to a side which confronts the bead transfer unit.

[FIG. 9] A partially sectioned side view of the bead transfer unit.

[FIG. 10] A front view of the bead transfer unit as viewed in an axial direction thereof.

[FIG. 11] A plan view showing a supporting construction of a main body portion of the bead transfer unit.

[FIG. 12] A front view of a loading and setting unit of the bead supply system as viewed from one side in an axial direction thereof.

[FIG. 13] A schematic side view of the loading and setting unit as viewed from a direction which intersects the axial direction at right angles.

[FIG. 14] An enlarged sectional view of part of the same unit.

[FIG. 15] A plan view of part of the same unit.

[FIG. 16] A front view, as viewed from an axial side, of part of the loading and setting unit which illustrates a displacement mechanism of a locking member in a radial direction.

[FIG. 17] A front view schematically showing a state of loading and setting on to a building machine.

[FIG. 18] A sectioned perspective view of an annular bead.

[FIG. 19] An exploded view of tire constituent members.

[FIG. 20] A sectional view showing a sectioned construction of a tire.

### DESCRIPTION OF REFERENCE CHARACTERS AND NUMERALS

A . . . bead supply system, D . . . building drum, T . . . tire, O1 . . . axial center of bead stocking unit, O2 . . . axial center of bead transfer unit, O3 . . . axial center of loading and setting unit, P1 . . . loading waiting position, P2 . . . loading and setting position, 1 . . . inner liner, 2 . . . tread, 3 . . . sidewall, 4 . . . chafer, 5 . . . pad underneath belt, 6 . . . carcass layer, 7 . . . belt layer, 8 . . . bead, 9 . . . reinforcement tape, 10 . . . bead stocking unit, 11a, 11b; 11c, 11d . . . upper and lower and left and right supporting arm portion, 12 . . . base table, 13 . . . supporting pillar, 14 . . . fixed table, 15 . . . shaft portion, 16 . . . gear wheel, 17 . . . rack, 18 . . . cylinder unit, 20a, 20b; 20c, 20d . . . transfer means, 21a, 22a; 21b, 22b . . . sprocket, 21c, 22c; 21d, 22d . . . sprocket, 23a, 23b; 23c, 23d . . . rotatable member, 24a, 24b; 24c, 24d . . . pin, 25a, 25b; 25c, 25d . . . drive means, 26 . . . bearing, 27 . . . supporting shaft, 28 . . . supporting plate, 28a . . . elongated hole, 29 . . . cylinder unit, 29a . . . engaging member, 31a, 31b; 31c, 31d . . . mounting plate, 32a, 32b; 32c, 32d . . . guide, 33, 37 . . . guide rail, 34, 38 . . . threaded shaft, 34a, 34b; 38c, 38d . . . inversely threaded portion, 35a, 35; 35c, 35d . . . threaded hole portion, 36, 39 . . . handle, 40 . . . bead transfer unit, 41 . . . main body portion, 41a . . . elongated hole, 42 . . . rail, 43 . . . base plate table, 44 . . . guide, 45 . . . mounting support plate, 46 . . . guide, 47 . . . guide rail, 48 . . . actuator, 49 . . . motor, . . . gear wheel, 51 . . . rack, 52 . . . locking member, 52a . . . locking stepped portion, 53 . . . guide, 54 . . . guide rail, 55 . . . lever, 56 . . . cylinder unit, 56a . . . output shaft, 57 . . . recessed groove member, 58 . . . arm member, 59 . . . annexed member, . . . loading and setting unit, 61 . . . main body portion, 62, . . . holding means, 64 . . . supporting base plate, 65 . . . supporting frame, 66 . . . movable table plate, 67 . . . coupling support member, 68 . . . guide rail, 69 . . . guide; M1 motor, 70 . . . gear wheel, 71 . . . rack, 72 . . . supporting tube, 73 . . . bearing, 74 . . . supporting shaft, 75 . . . frame member, 76 . . . gear wheel, 77 . . . rack, 78 . . . guide member, 79 . . . cylinder unit, 80 . . . tubular barrel portion, 81 . . . mounting plate, 82, 83 . . . locking member, 82a, 83a . . . locking stepped portion, 82b, 83b . . . main body portion, 84 . . . movable plate, 85 . . . holding plate, 86 . . . guide rail, 87 . . . guide, 88 . . . inclined hole, 89 . . . elongated hole, 90 . . . roller, 91 . . . shaft member, 92a, 92b . . . rotatable supporting member, 93a, 93b . . . coupling member, 94a, 94b . . . cylinder unit, 95a . . . cut-out portion, . . . building machine, 101, 102 . . . supporting element.

1. A bead supply system in a tire building process for in bead setting and turning up steps in tire building, supplying an annular bead made up by having a bead core and a bead filler to a building machine which supports a building drum in the steps, the bead supply system comprising:
a bead stocking unit having a supporting arm portion which is supported horizontally at one end portion so that a plurality of the beads are locked from inner circumferences thereof so as to be held in such a manner as to be spaced apart at constant intervals along the supporting arm portions and transfer means for transferring the beads so held intermittently towards an open end of the supporting arm portion so that the beads are fed out one by one;
a bead transfer unit having a holding means for receiving the beads, one by one, which are fed out from an end portion of the transfer means which lies at the open end while supporting the bead on the inner circumference thereof and holding the beads so received in a position which confronts the bead stocking unit and adapted to move from the confronting position to a loading waiting position on to the building machine while holding the beads; and
a loading and setting unit having a holding means for receiving the beads from the bead transfer unit while supporting the bead on the inner circumference thereof and holding the beads so received in the loading waiting position and adapted to move to a position where to confront two supporting elements of the building machine while holding the beads so as to enabling loading and setting of the beads on to both the supporting elements, characterized in that
the bead stocking unit is configured such that the one end portion of the supporting arm portion is fixed continuously to a supporting pillar provided on a rotatable base table in such a manner as to be erected therefrom so that the supporting arm portion is supported horizontally, and that the transfer means is provided along the supporting arm portion, whereby by rotating the base table with a required number of beads locked on the transfer means, the end portion of the transfer means which lies at the open end is directed from a non-confronting side to a confronting side with the bead transfer unit; and
the respective units are operated in an associated fashion in accordance with a tire building cycle so that the beads can be loaded and set on both the supporting elements of the building machine.

2. (canceled)

3. A bead supply system in a tire building process as set for in claim 1, wherein upper and lower transfer means are provided on the bead stocking unit for holding the bead at upper and lower portions on the inner circumference thereof in a locked state in such a manner as to be driven along the supporting arm portion in synchronism with each other.

4. A bead supply system in a tire building process as set forth in claim 3, wherein left and right transfer means for holding the bead at left and right portions on the inner circumference thereof in a locked state are provided in left and right positions which lie vertically intermediate between the upper and lower transfer means in such a manner as to be driven along the supporting arm portion in synchronism with the upper and lower transfer means.

5. A bead supply system in a tire building process as set forth in any one of claims 1, 3 or 4, wherein the transfer means of the bead stocking unit is made up of an endless rotatable member which can rotate backwards and forwards and which has pins provided on an external surface thereof at constant intervals in such a manner as to project therefrom for holding the beads in such a manner as to be spaced apart from each other, and that the pins are provided in such a manner as to turn in such a manner as to project from a distal end of the supporting arm portion at a turning portion of the rotatable member at the open-end end portion.

6. A bead supply system in a tire building process as set forth in any one of claims 1, 3 or 4, wherein the bead transfer unit is provided in such a manner as to move in an approaching direction relative to the end portion of the transfer means at least in a position which confronts the end portion of the transfer means of the bead stocking unit which lies at the open end.

7. A bead supply system in a tire building process as set forth in claim 6, wherein the bead transfer unit comprises as a holding means for holding a bead a plurality of locking members adapted to be locked on an inner circumferential edge of the bead which are provided in such a manner as to be displaced in a radial direction in synchronism with each other in positions which are located at required intervals in a circumferential direction on a side which confronts the end portion of the transfer means which lies at the open end.

8. A bead supply system in a tire building process as set forth in any one of claims 1, 3 or 4, wherein the loading and setting unit comprises a holding means for receiving the bead from the bead transfer unit to hold the bead thereon which is provided on each of both axial surfaces thereof, which is supported in such a manner as to be turned so that the holding means on both the surfaces are directed alternately to a side which confronts the bead transfer unit, and which is made to move to the position where to confront the two supporting elements of the building machine while holding two beads with the holding means on both the surfaces.

9. A bead supply system in a tire building process as set forth in claim 5, wherein the loading and setting unit comprises holding means for receiving the bead from the bead transfer unit to hold the bead thereon which is provided on each of both axial surfaces thereof, which is supported in such a manner as to be turned so that the holding means on both the surfaces are directed alternately to a side which confronts the bead transfer unit, and which is made to move to the position where to confront the two supporting elements of the building machine while holding two beads with the holding means on both the surfaces.
